(19) United States
(12) Patent Application Publication
(10) Pub. No.: US 2013/0316303 A1
(43) Pub. Date: Nov. 28, 2013

(54) NARROWED IMPLANT BODY

(71) Applicant: Bernard Weissman, New York, NY (US)

(72) Inventor: Bernard Weissman, New York, NY (US)

(73) Assignee: DENTATUS USA LTD., New York, NY (US)

(21) Appl. No.: 13/983,819

(22) PCT Filed: Feb. 9, 2012
(86) PCT No.: PCT/US12/24410

§ 371 Date: Aug. 6, 2013

Related U.S. Application Data
(60) Provisional application No. 61/441,037, filed on Feb. 9, 2011.

(51) Int. Cl. A61C 8/00

(52) U.S. Cl. CPC A61C 8/0022; A61C 8/0075
USPC 433/174

(57) ABSTRACT

A dental implant includes a crown socket; an abutment; and an implant body having a shank that includes a threaded portion and a narrowing portion for increasing an offset distance to a tooth root adjacent to the implant body, the narrowing portion having an absence of threads. In another embodiment, a dental implant includes an implant body having a threaded tip portion distal from the abutment, a shank portion between the tip and the abutment, the shank portion having an unthreaded portion and a threaded portion in one cross-section through the shank portion.

### CROSS-REFERENCE TO RELATED APPLICATIONS

This application is a non-provisional counterpart to and claims priority from U.S. Ser. No. 61/441,037, filed on Feb. 9, 2011, which is pending and which is hereby incorporated in its entirety for all purposes.

### BACKGROUND OF THE INVENTION

1. Field of the Invention

The present invention relates to improvements in prosthetic implant bodies for implant dentistry.

2. Discussion of the Related Art

In implant dentistry, a replacement tooth is permanently secured to a patient's maxilla, i.e., upper jaw, or the mandible, i.e., jaw bone, by taking advantage of the body's willingness to osseointegrate certain materials. The replacement tooth comprises an implant body, typically made of titanium, which is secured into an opening, i.e., osteotomy, which has been previously prepared by a dentist or dental surgeon, i.e., dentist, in the patient, i.e., implant site. In due course, the natural bone adheres to the implant body. After a certain period, a physiologically correct crown is secured to the crown socket of the implant to provide a prosthetic tooth that can be used like a natural tooth.

A satisfactory implantation meets two conditions: (1) an implant body is secured to solid bone and (2) the crown of the implant (or the crown of a bridge supported by one or more implants) is properly aligned relative to the crown of the adjacent teeth to meet the patient's functional and aesthetic needs.

FIG. 1a is a schematic plan view of an idealized jaw and FIG. 1b is a partial rear view of the idealized jaw of FIG. 1a. FIG. 1c is a schematic plan view of the implant spaces for the idealized jaw of FIG. 1a. FIG. 1d is a partial rear view of the idealized jaw of FIG. 1a.

Therein, a mandibular jaw 2 includes teeth 3 that are spaced-apart at a preferred distance from each other such that the teeth develops normally and meet the patient's functional and aesthetic needs. When a patient is in need of an implant, one or more suitable implant bodies can be placed into respective implant spaces 4 that do not interfere with each other.

FIG. 2a is a schematic plan view of a non-idealized jaw. FIG. 2c is a schematic plan view of the implant spaces for the non-idealized jaw of FIG. 2a. FIG. 2d is a detail view of one or more interference regions. FIG. 2e is a partial rear view of the non-idealized jaw of FIG. 2c indicating the one or more interference regions of 2c. Therein, a mandibular jaw 2a includes teeth 3a that are spaced-apart at a non-idealized distance from each other. Although, the teeth are not ideal, they have developed substantially normally and substantially meet the patient's functional and aesthetic needs. However, when a patient is in need of an implant, one or more suitable implant bodies will need to be placed into respective implant spaces 4a that may interfere with each other in interference regions 5a.

Although, a mandibular jaw is illustrated in FIGS. 1a, 1b, 1c, 2a, 2b, 2c, 2d, and 2e the same situation arises in a maxillary jaw.

Thus, what is needed is an implant body that is narrowed and permits implantation in the jaw of a patient when the teeth are spaced such that one or more full body implants may interfere with each other.

The following patents and/or applications hereby incorporated by reference in their entirety for all purposes: U.S. Pat. No. 5,785,525 and U.S. Pat. No. 6,685,473.

### SUMMARY OF THE INVENTION

These and other needs are met by the present invention.

A dental implant includes a crown socket; an abutment; and an implant body having a shank that includes a threaded portion and a narrowing portion for increasing an offset distance to a tooth root adjacent to the implant body, the narrowing portion having an absence of threads. In another embodiment, a dental implant includes an implant body having a threaded tip portion distal from the abutment, a shank portion between the tip and the abutment, the shank portion having an unthreaded portion and a threaded portion in one cross-section through the shank portion.

### BRIEF DESCRIPTION OF THE DRAWINGS

FIG. 1a is a schematic plan view of an idealized jaw.

FIG. 1b is a partial rear view of the idealized jaw of FIG. 1a.

FIG. 1c is a schematic plan view of the implant spaces for the idealized jaw of FIG. 1a.

FIG. 1d is a partial rear view of the idealized jaw of FIG. 1c indicating the implant spaces.

FIG. 2a is a schematic plan view of a non-idealized jaw.

FIG. 2b is a partial rear view of the non-idealized jaw of FIG. 2a.

FIG. 2c is a schematic plan view of the implant spaces for the non-idealized jaw of FIG. 2a.

FIG. 2d is a detail view of one or more interference regions.

FIG. 2e is a partial rear view of the non-idealized jaw of FIG. 2c indicating the one or more interference regions of 2c.

FIG. 3a is a side view of an implant in accordance with one or more embodiments of the present invention.

FIG. 3b is a front view of the implant of FIG. 3a.

FIG. 3c is a planar view of the implant of FIG. 3a.

FIG. 3d is a cross-sectional view of an implant body of FIGS. 3a and 3b taken at line A-A.

FIG. 3e is a cross-sectional view of an implant body of FIGS. 3a and 3b taken at line B-B.

FIG. 3f is a detail view of one or more non-interference regions in accordance with one or more embodiments of the present invention.

FIG. 3g is a partial front view of the non-idealized jaw of FIG. 2c wherein an implant body in accordance with one or more embodiments of the present invention has been installed.

FIG. 4 is a dimensioned sketch of the invention in accordance with one or more embodiments of the present invention.

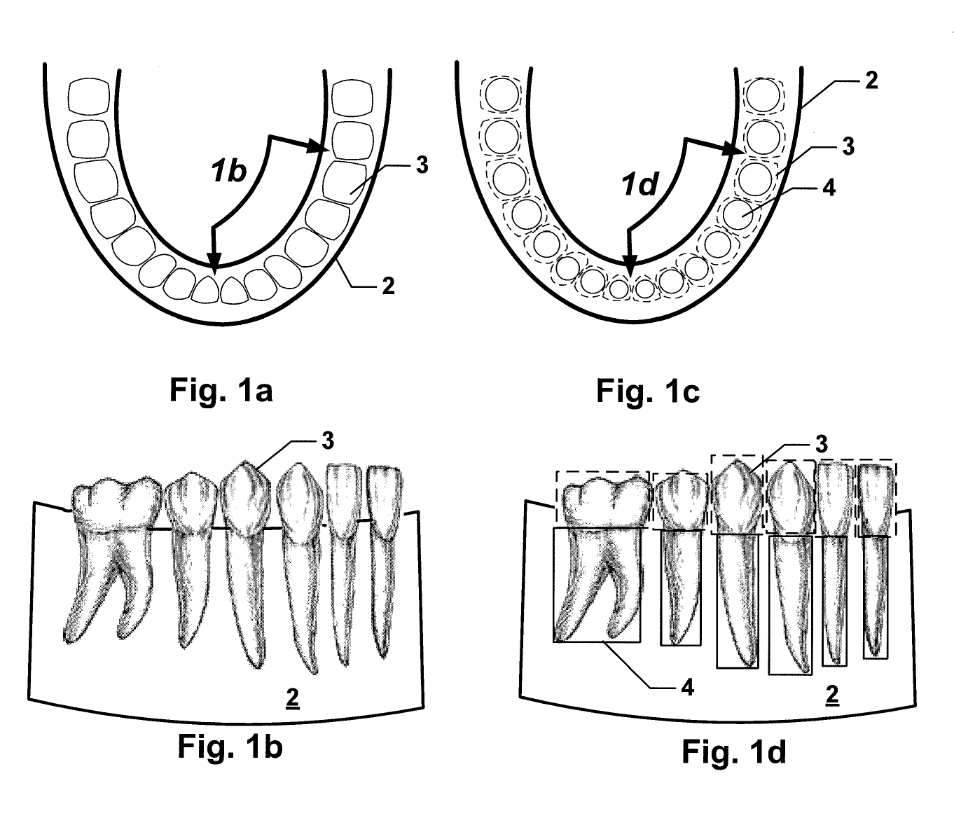

### DETAILED DESCRIPTION OF THE INVENTION

Reference will now be made in detail to several views of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, left, right, up, down, over, above, below, beneath, rear, and front may be used with respect to the drawings.

These and similar directional terms should not be construed to limit the scope of the invention in any manner. The words “connect,” “couple,” and similar terms with their inflectional morphemes do not necessarily denote direct and immediate connections, but also include connections through mediate elements or devices.

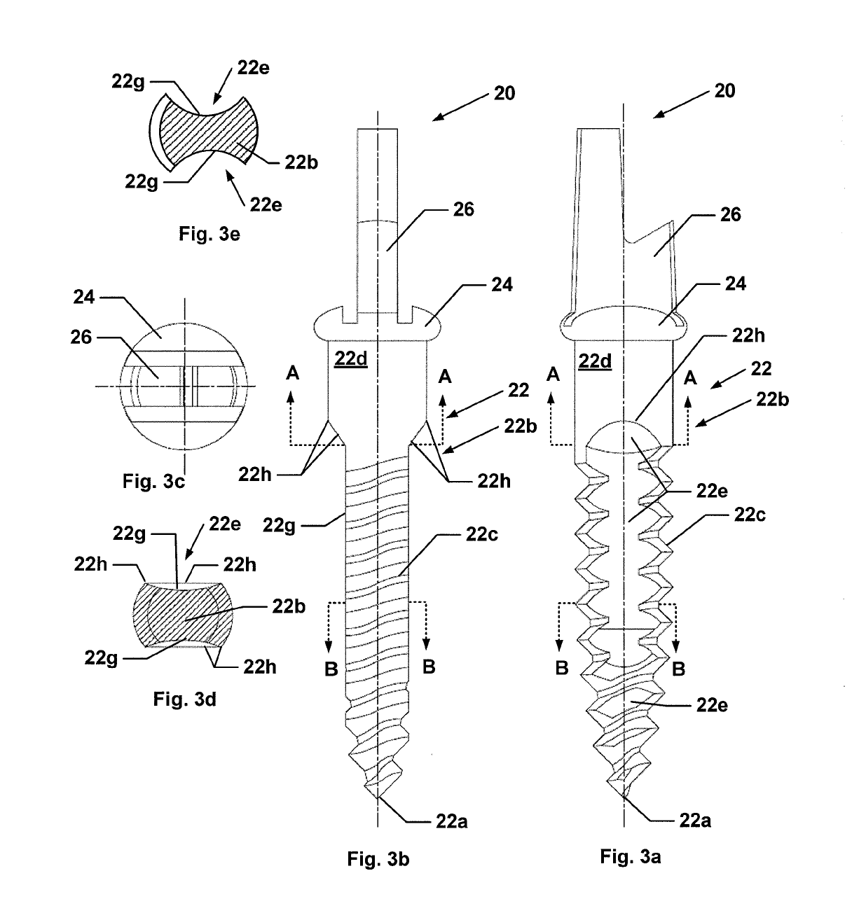

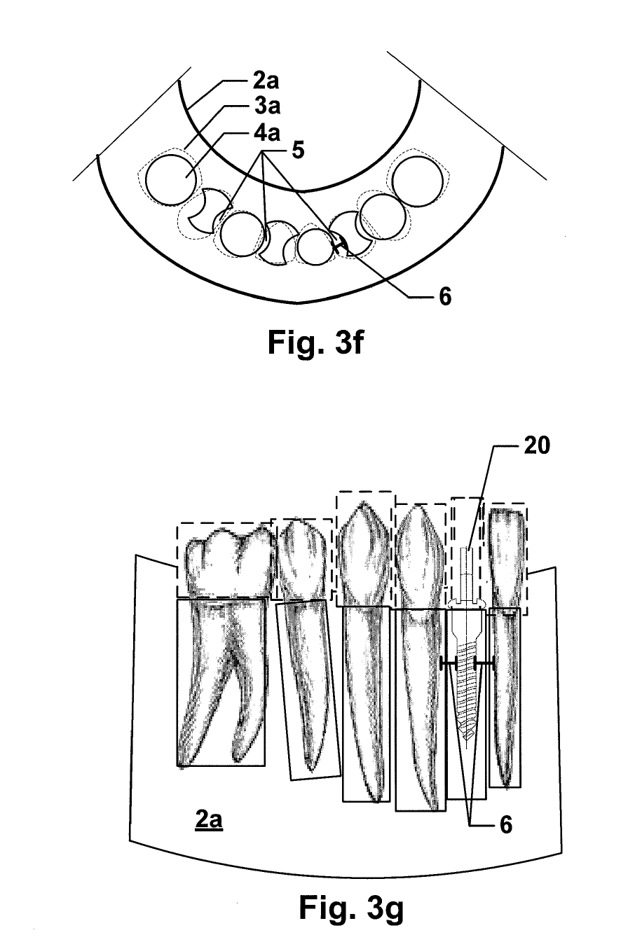

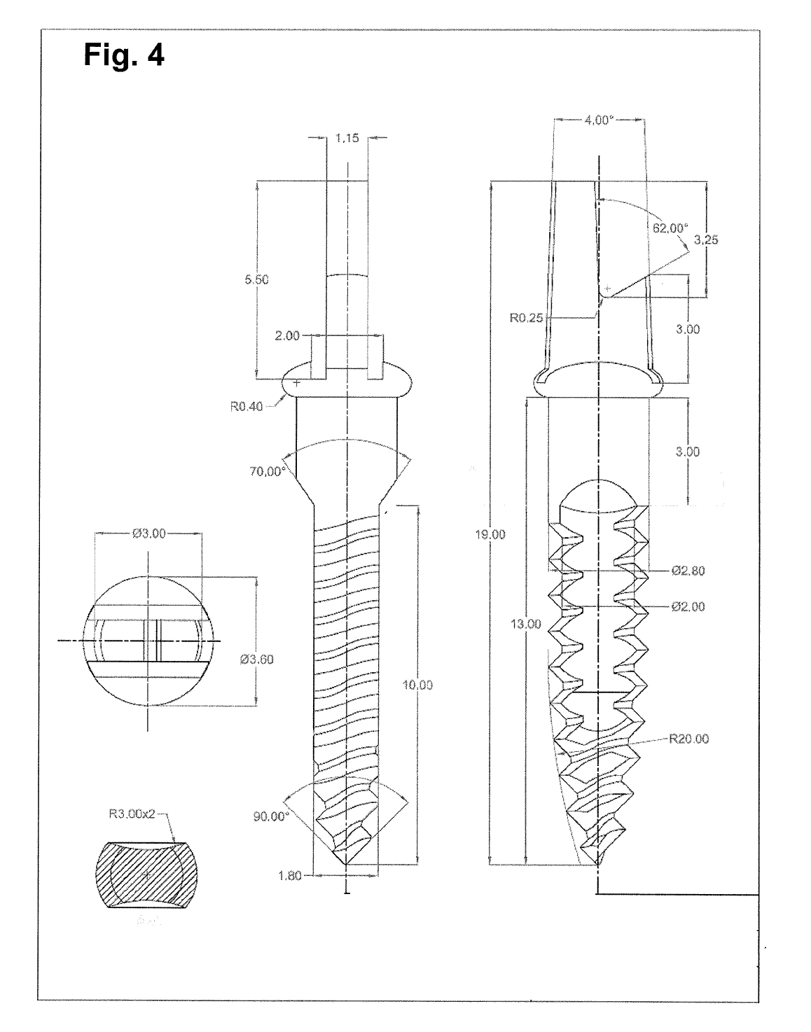

FIG. 3a is a side view of an implant in accordance with one or more embodiments of the present invention. FIG. 3b is a front view of the implant of FIG. 3a. FIG. 3c is a planar view of the implant of FIG. 3a. FIG. 3d is a cross-sectional view of an implant body of FIGS. 3a and 3b taken at line A-A. FIG. 3e is a cross-sectional view of an implant body of FIGS. 3a and 3b taken at line B-B. FIG. 4 is a dimensioned sketch of the invention in accordance with one or more embodiments of the present invention.

In accordance with one or more embodiments of the present invention, an implant 20 supports a prosthetic tooth in an anatomically correct shape of a maxillary or mandibular tooth. The implant includes a narrowed implant body 22 (also known as a post), an abutment 24, and a head portion, i.e., crown socket 26.

Abutment 24 and/or crown socket 26 may be one as known in U.S. Ser. No. 12/613,017, published as U.S. Patent Application Publication 2011/0104637. U.S. Ser. No. 12/613,017, published as U.S. Patent Application Publication 2011/0104637, is hereby incorporated by reference in its entirety for all purposes. Abutment 24 may also be any suitable type of abutment that is known in the art, but is preferably one made according to the teachings of U.S. Pat. No. 5,785,525 and/or U.S. Pat. No. 6,685,473, which are herein incorporated in their entirety for all purposes.

Implant body 22 preferably comprises a distal end 22a, defining a tip portion, for being received first in a patient's jaw as is known in the art. A shank 22b includes a threaded portion 22c having a helical thread or other thread known in the art and preferably is self-tapping. An unthreaded, e.g., bare, portion 22d may be provided spaced from the distal end to permit specific types of osteotomies or for any reason suitable for a dental professional.

One or more narrowing portions 22e are disposed in shank 22b and/or unthreaded portion 22 and comprise an indented surface 22f. Surface 22f may be any suitable shaped surface, but preferably comprises, in a transverse, i.e., cross-sectional, plane, a flat side or an arcuate edge 22g and in the unthreaded portion 22d comprises an angular edge 22h.

Therein, the arcuate edge and/or angled preferably has a diameter that is suitable for the length of the shank to maintain stability. Thus, edge 22g may have a diameter of 3 mm for a 10 mm shank and/or edge 22h may have an angle of 70 degrees relative to the transverse, i.e., cross-sectional, plane.

Implant body 22 may be made of a solid titanium alloy having 1.8 mm to 2.8 mm diameter and is 3-4 mm in length.

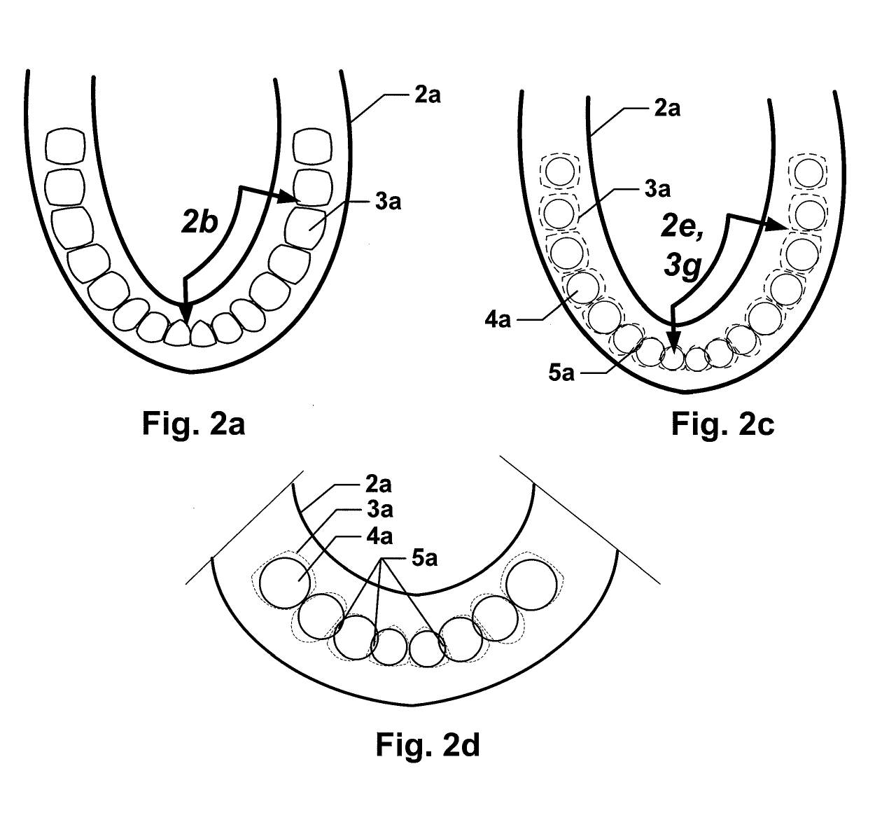

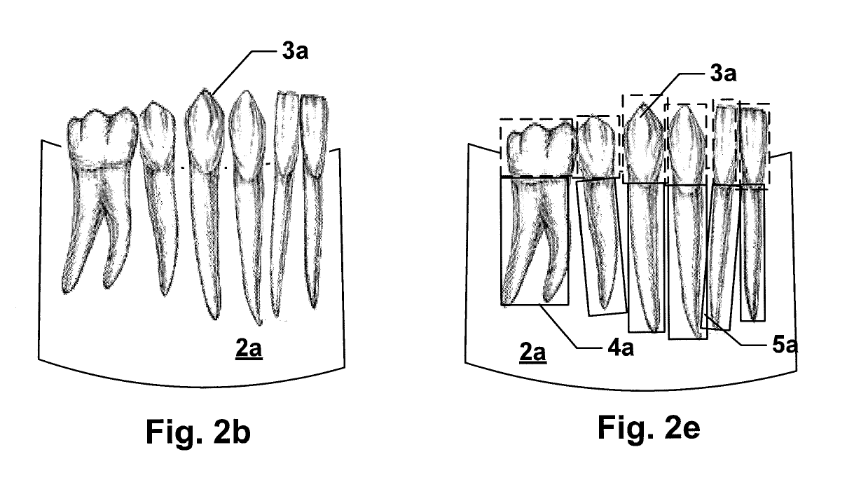

FIG. 3f is a detail view of one or more non-interference regions in accordance with one or more embodiments of the present invention. FIG. 3g is a partial front view of the non-idealized jaw of FIG. 2c wherein an implant body in accordance with one or more embodiments of the present invention has been installed. When installing the implant body, the implant body is secured to the jaw of the patient such that the abutment is aligned with the gingiva as medically required. The implant body 22 may then be located via turning that when a subsequent implant, i.e., implant body having a full diameter, i.e., full width is installed there are no interferences, i.e., non-interference regions 5 are present, and offsets 6 are sufficient as is medically necessary to provide a superior implant location.

While the invention has been described in conjunction with specific embodiments, it is to be understood that many alternatives, modifications, and variations will be apparent to those skilled in the art in light of the foregoing description.

What is claimed is:

1. A dental implant comprising:
a crown socket;
an abutment; and
an implant body having a shank comprising a threaded portion and a narrowing portion for increasing an offset distance to a tooth root adjacent to the implant body, the narrowing portion comprising an absence of threads.

2. The dental implant of claim 1, wherein the narrowing portion comprises an arcuate edge in cross-section of the shaft.

3. The dental implant of claim 1, wherein the shank comprises two narrowing portions, each narrowing portions on an opposite side of the shaft.

4. The dental implant of claim 1, wherein the shank in cross-section alternates a threaded portion with a narrowing portion.

5. The dental implant of claim 1, wherein the shank comprises an unthreaded portion adjacent to the abutment.

6. A dental implant comprising:
a crown socket;
an abutment; and
an implant body, the implant body comprising a shaft having in one cross-section
a first longitudinal side comprising an unthreaded portion for providing an offset to an adjacent tooth root when installed in a mouth of a patient, and
a second longitudinal side having threads.

7. The dental implant of claim 6, wherein the shaft comprises a third longitudinal side having a second smooth unthreaded portion.

8. The dental implant of claim 7, wherein the first and third longitudinal sides are spaced apart by the second longitudinal side.

9. The dental implant of claim 6, wherein the first longitudinal side comprises a smooth surface.

10. The dental implant of claim 6, wherein the first longitudinal side comprises an arcuate edge in the cross-section.

11. The dental implant of claim 6, wherein the shank further comprises an unthreaded portion adjacent to the abutment.

12. A dental implant comprising:
a crown socket;
an abutment;
an implant body comprising
a threaded tip portion distal from the abutment,
a shank portion between the tip and the abutment, the shank portion comprising an unthreaded portion and a threaded portion in one cross-section through the shank portion.

13. The dental implant of claim 12, wherein the unthreaded portion comprises an arcuate edge in the cross-section.

14. The dental implant of claim 12, wherein the shank portion comprising a second unthreaded portion in the cross-section.

15. The dental implant of claim 12, wherein the cross-section is symmetric.
